(19) United States
(12) Patent Application Publication
(10) Pub. No.: US 2024/0123793 A1
(43) Pub. Date: Apr. 18, 2024

(54) VEHICULAR AIR CONDITIONING SYSTEM

(71) Applicant: Hanon Systems, Daejeon (KR)

(72) Inventors: Jun Min LEE, Daejeon (KR); Yong Sik KIM, Daejeon (KR); Chan Young LEE, Daejeon (KR); Joong Man HAN, Daejeon (KR)

(21) Appl. No.: 18/277,396

(22) PCT Filed: Apr. 26, 2022
(86) PCT No.: PCT/KR2022/005893

§ 371 Date: Aug. 16, 2023

(30) Foreign Application Priority Data
Apr. 27, 2021 (KR) 10-2021-0054173

(51) Int. Cl. B60H 1/00

(52) U.S. Cl. CPC B60H 1/0073; B60H 1/00392; B60H 2001/3292

(57) ABSTRACT

A vehicular air conditioning system includes a compressor configured to compress a gaseous refrigerant to have a high temperature and a high pressure while an output rotation speed thereof is variably controlled according to a cooling load in a vehicle interior, and a compressor performance deterioration determination part configured to determine whether or not the performance of the compressor has deteriorated according to the magnitude of a difference between an amount of work (W) of the compressor and an amount of power consumption (kW) of the compressor.

### TECHNICAL FIELD

The present invention relates to a vehicular air conditioning system, and more particularly, a vehicular air conditioning system capable of determining the performance deterioration of a compressor through a preset logic and informing a user of a determination result so that the user can take a prompt measure when the performance of the compressor deteriorates.

### BACKGROUND ART

A motor vehicle is provided with an air conditioning system for cooling and heating the vehicle interior, and the air conditioning system includes a compressor.

The compressor compresses a gaseous refrigerant to have a high temperature and a high pressure. The output rotation speed (rpm) of the compressor is variably controlled according to the cooling load in the vehicle interior. The compressor variably controlled in this manner compresses the gaseous refrigerant in an optimal state according to the cooling load in the vehicle interior while operating at an optimal torque.

In the case of an engine-type vehicle, the compressor is operated by receiving power from the engine. In the case of an electric vehicle such as an electric car, a hybrid vehicle, or a fuel cell vehicle, the compressor is operated by the electric power of a battery as a power source.

Meanwhile, such a compressor has a disadvantage in that the refrigerant compression efficiency thereof rapidly decreases as the durability thereof is reduced due to a specific cause or over time. For example, the refrigerant compression efficiency may rapidly decrease as the durability thereof is reduced due to wear and damage of each internal sliding part.

This may reduce the cooling performance in the vehicle interior, and the energy consumption may be increased, thereby reducing the fuel efficiency of the vehicle.

In particular, in the case of an electric vehicle, the energy consumption greatly affects the mileage of the vehicle. Therefore, the mileage of the vehicle is remarkably shortened due to the increase in energy consumption caused by the decrease in compression efficiency of the compressor.

In addition, the compressor with reduced compression efficiency often breaks down. In this case, the air conditioning operation for the vehicle interior is completely stopped. Therefore, it is impossible to cool the vehicle interior during the compressor repair period, consequently making the user inconvenient.

### SUMMARY

In view of the problems inherent in the related art, it is an object of the present invention to provide a vehicular air conditioning system capable of determining the performance deterioration of a compressor through a preset logic, and informing a user of a determination result.

Another object of the present invention is to provide a vehicular air conditioning system capable of enabling a user to take a prompt measure when the performance of a compressor deteriorates, and consequently preventing the deterioration of the cooling performance for the vehicle interior and the excessive energy consumption due to the performance deterioration of the compressor.

A further object of the present invention is to provide a vehicular air conditioning system capable of improving the comfort in the vehicle interior and the fuel efficiency of a vehicle.

In order to achieve these objects, there is provided a vehicular air conditioning system, including: a compressor configured to compress a gaseous refrigerant to have a high temperature and a high pressure while an output rotation speed thereof is variably controlled according to a cooling load in a vehicle interior; and a compressor performance deterioration determination part configured to determine whether or not the performance of the compressor has deteriorated according to the magnitude of a difference between an amount of work (W) of the compressor and an amount of power consumption (kW) of the compressor.

The amount of work of the compressor may be determined by using a low pressure side refrigerant pressure value at an inlet of the compressor and a high pressure side refrigerant pressure value at an outlet of the compressor.

The amount of work of the compressor may be determined according to a ratio of a high pressure side refrigerant pressure to a low pressure side refrigerant pressure.

The amount of work of the compressor may be determined according to a rotation speed of the compressor.

The compressor performance deterioration determination part may be configured to calculate a discrepancy rate between the amount of work (W) of the compressor and the amount of power consumption (kW) of the compressor in real time by the following formula [1]: discrepancy rate=amount of work (W) of compressor/amount of power consumption (kW) of compressor, and determine whether or not the performance of the compressor has deteriorated depending on whether or not the discrepancy rate between the amount of work (W) of the compressor and the amount of power consumption (kW) of the compressor falls within a range larger than a predetermined first set value and smaller than a predetermined second set value set to be larger than the first set value as represented by the following formula [2]: first set value<discrepancy rate<second set value.

If the discrepancy rate between the amount of work (W) of the compressor and the amount of power consumption (kW) of the compressor falls within the range larger than the first set value and smaller than the second set value, the compressor performance deterioration determination part may determine that the performance of the compressor is normal.

If the discrepancy rate between the amount of work (W) of the compressor and the amount of power consumption (kW) of the compressor is equal to or smaller than the first set value or equal to or larger than the second set value, the compressor performance deterioration determination part may determine that the performance of the compressor has deteriorated.

The compressor performance deterioration determination part may determine that the performance of the compressor has deteriorated, only when the discrepancy rate between the amount of work (W) of the compressor and the amount of power consumption (kW) of the compressor continues to be equal to or smaller than the first set value or equal to or larger than the second set value for a predetermined time or more.

The system may further include: a compressor performance deterioration display part configured to indicate the deterioration of performance of the compressor with at least one of a symbol, a sign and a letter and inform a user of the deterioration of performance of the compressor when the compressor performance deterioration determination part determines that the performance of the compressor has deteriorated.

The compressor performance deterioration display part may be a display part of a controller for controlling the vehicular air conditioning system: The first set value may be 0.75, and the second set value may be 1.25.

According to the vehicular air conditioning system of the present invention, it is possible to determine the performance deterioration of the compressor based on the amount of work of the compressor and the amount of power consumption of the compressor, and notify the user of the determination result.

In addition, since the performance deterioration of the compressor is determined and notified to the user, it is possible for the user to take a prompt measure when the performance of the compressor deteriorates. This makes it possible to prevent the deterioration in cooling performance of the vehicle interior and the excessive energy consumption due to the deterioration in performance of the compressor.

In addition, since the deterioration in cooling performance of the vehicle interior and the excessive energy consumption due to the deterioration in performance of the compressor can be prevented, it is possible to improve the comfort in the vehicle interior and the fuel efficiency of the vehicle.

### BRIEF DESCRIPTION OF THE DRAWINGS

FIG. 1 is a view showing the configuration of a vehicular air conditioning system according to the present invention.

FIG. 2 is a flowchart showing an operation example of the vehicular air conditioning system according to the present invention.

### DETAILED DESCRIPTION

A preferred embodiment of a vehicular air conditioning system according to the present invention will now be described in detail with reference to the accompanying drawings.

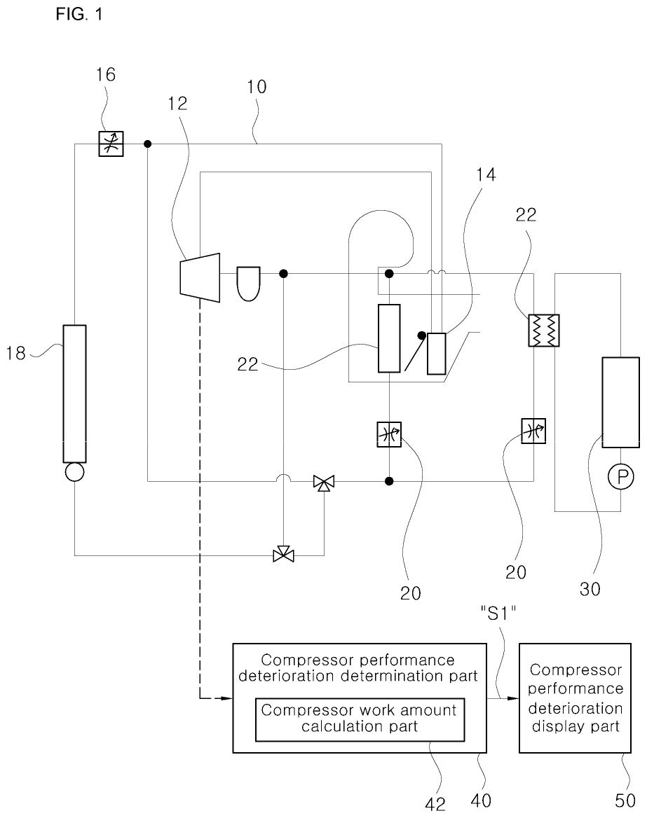

Prior to describing the features of a vehicular air conditioning system according to the present invention, a heat pump type vehicular air conditioning system will be briefly described with reference to FIG. 1.

The air conditioning system includes a refrigerant circulation line 10.

The refrigerant circulation line 10 includes a compressor 12, a high pressure side heat exchanger 14, a heat pump mode expansion valve 16, an outdoor heat exchanger 18, a plurality of air conditioner mode expansion valves 20 installed in parallel with each other, and low pressure side heat exchangers 22 installed downstream of the air conditioner mode expansion valves 20.

The refrigerant circulation line 10 completely opens the heat pump mode expansion valve 16 in an air conditioner mode.

Therefore, the refrigerant of the compressor 12 is circulated in the order of the high pressure side heat exchanger 14, the outdoor heat exchanger 18, the air conditioner mode expansion valve 20 and the low pressure side heat exchanger 22.

In addition, a low temperature cold air is generated in the low pressure side heat exchangers 22 through the circulation of the refrigerant, and the generated cold air is transferred to an air conditioning region of the vehicle, for example, a vehicle interior and a battery 30. In this way, the vehicle interior and the battery 30 are cooled.

Further, in the heat pump mode, the heat pump mode expansion valve 16 is turned on to allow the refrigerant to be decompressed and expanded.

Therefore, the refrigerant of the compressor 12 can be circulated in the order of the high pressure side heat exchanger 14, the heat pump mode expansion valve 16 and the outdoor heat exchanger 18.

In addition, high temperature heat is generated in the high pressure side heat exchanger 14 through the circulation of the refrigerant, and the generated heat is supplied to the vehicle interior to heat the vehicle interior.

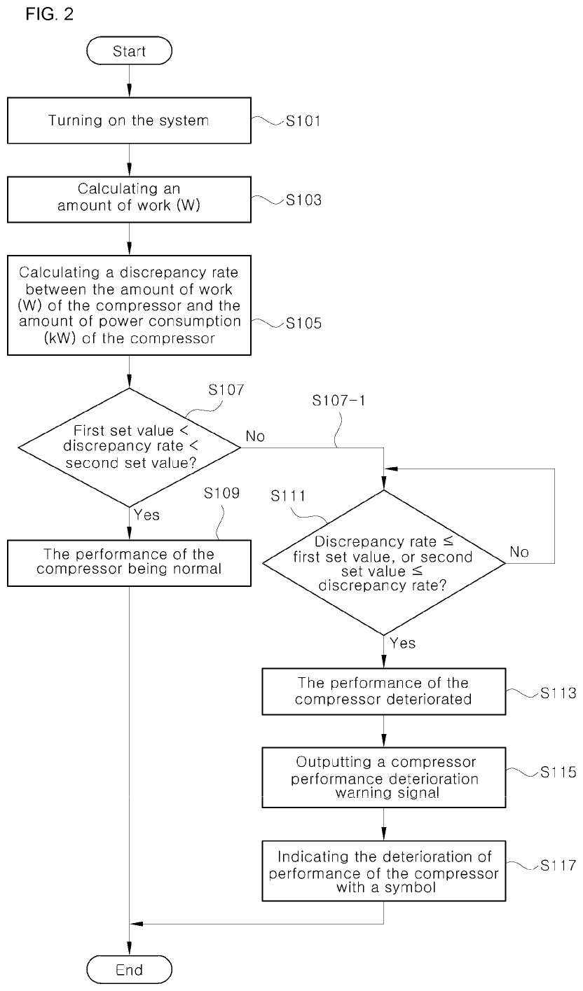

Next, the features of the vehicular air conditioning system according to the present invention will be described in detail with reference to FIGS. 1 and 2.

Referring first to FIG. 1, the vehicular air conditioning system of the present invention includes a compressor performance deterioration determination part 40 for determining whether or not the performance of the compressor 12 has deteriorated.

The compressor performance deterioration determination part 40 includes a microprocessor, and determines whether or not the performance of the compressor 12 has deteriorated based on the factors for determining the performance of the compressor 12, for example, the amount of work (W) of the compressor 12 and the amount of power consumption of the compressor 12 (kW). In particular, the compressor performance deterioration determination part 40 determines whether or not the performance of the compressor 12 has deteriorated according to the above factors, i.e., the magnitude of the difference between the amount of work (W) of the compressor 12 and the amount of power consumption (kW) of the compressor 12.

More specifically, the compressor performance deterioration determination part 40 includes a compressor work amount calculation part 42.

The compressor work amount calculation part 42, as a kind of calculation program, calculates the amount of work (W) of the compressor 12 in real time by processing data such as the compressor rotation speed (rpm) inputted from the compressor 12, the specific heat ratio (Cp/Cv) of the refrigerant, and the ratio of low pressure and high pressure in the system.

Preferably, the compressor work amount calculation part 42 may determine the amount of work (W) of the compressor 12 by using the low pressure side refrigerant pressure value at the inlet of the compressor 12 and the high pressure side refrigerant pressure value at the outlet of the compressor 12.

In particular, the compressor work amount calculation part 42 may calculate the amount of work (W) of the compressor 12 according to the value obtained by dividing the high pressure side refrigerant pressure value at the outlet of the compressor 12 by the low pressure side refrigerant pressure value at the inlet of the compressor 12.

Therefore, the compressor work amount calculation part 42 determines that the amount of work (W) of the compressor 12 is large if the ratio of the high pressure side refrigerant pressure to the low pressure side refrigerant pressure is large.

In some cases, the compressor work amount calculation part 42 may determine the amount of work (W) of the compressor 12 according to the rotation speed (rpm) of the compressor 12.

Therefore, the compressor work amount calculation part 42 determines that the amount of work (W) of the compressor 12 is large if the rotation speed (rpm) of the compressor 12 is high.

Since the calculation formula of the amount of work of the compressor is already known in the art, the detailed description thereof will be omitted.

Meanwhile, when the amount of work (W) of the compressor is calculated by the compressor work amount calculation part 42, the compressor performance deterioration determination part 40 calculates a discrepancy rate between the amount of work (W) of the compressor and the amount of power consumption (kW) of the compressor in real time by the following formula [1]:

discrepancy rate=amount of work (W) of compressor/amount of power consumption (kW) of compressor [1]

When the discrepancy rate between the amount of work (W) of the compressor and the amount of power consumption (kW) of the compressor is calculated, the compressor performance deterioration determination part 40 determines in real time whether the discrepancy rate between the amount of work (W) of the compressor and the amount of power consumption (kW) of the compressor falls within a range larger than a predetermined first set value and smaller than a predetermined second set value set to be larger than the first set value as represented by the following formula [2]:

first set value<discrepancy rate<second set value [2]
If the result of determination indicates that the discrepancy rate between the amount of work (W) of the compressor and the amount of power consumption (kW) of the compressor falls within a range larger than the first set value and smaller than the second set value, the compressor performance deterioration determination part 40 determines that the amount of work (W) of the compressor 12 is maintained at a specified level with respect to the amount of power consumption (kW) of the compressor 12, and recognizes that the performance of the compressor 12 is normal.

If the discrepancy rate between the amount of work (W) of the compressor and the amount of power consumption (kW) of the compressor is equal to or smaller than the first set value or equal to or larger than the second set value, the compressor performance deterioration determination part 40 determines that the amount of work (W) of the compressor 12 is much lower than or much higher than the amount of power consumption (kW) of the compressor 12 and the performance of the compressor 12 is abnormal.

That is, if the discrepancy rate between the amount of work (W) of the compressor and the amount of power consumption (kW) of the compressor is equal to or smaller than the first set value, the compressor performance deterioration determination part 40 determines that the amount of work (W) of the compressor 12 is much lower than the amount of power consumption (kW) of the compressor 12, and further determines that the performance of the compressor 12 is abnormal. For example, the compressor performance deterioration determination part 40 determines that each sliding part of the compressor 12 is excessively worn and the performance of the compressor 12 is significantly deteriorated.

If the discrepancy rate between the amount of work (W) of the compressor and the amount of power consumption (kW) of the compressor is equal to or larger than the second set value, the compressor performance deterioration determination part 40 determines that the amount of work (W) of the compressor 12 is much higher than the amount of power consumption (kW) of the compressor 12, and recognizes that the performance of the compressor 12 is abnormal. Based on this recognition, the compressor performance deterioration determination part 40 determines that the performance of the compressor 12 is significantly deteriorated.

It is preferable that the first set value, which is a criterion for determining whether or not the performance of the compressor 12 has deteriorated, is set to 0.75, and the second set value is set to 1.25.

If the discrepancy rate between the amount of work (W) of the compressor and the amount of power consumption (kW) of the compressor is 0.75 or less, the deterioration of performance of the compressor 12 occurs due to the reduced durability.

If the discrepancy rate between the amount of work (W) of the compressor and the amount of power consumption (kW) of the compressor is 1.25 or more, the deterioration of performance of the compressor 12 occurs due to a specific cause.

Meanwhile, the compressor performance deterioration determination part 40 does not immediately determine that the deterioration of performance of the compressor 12 has occurred even when the discrepancy rate between the amount of work (W) of the compressor and the amount of power consumption (kW) of the compressor is equal to or smaller than the first set value or equal to or larger than the second set value.

Instead, the compressor performance deterioration determination part 40 determines that the deterioration of performance of the compressor 12 has occurred only when the discrepancy rate between the amount of work (W) of the compressor and the amount of power consumption (kW) of the compressor continues to be equal to or smaller than the first set value or equal to or larger than the second set value for a predetermined time or more. For example, the compressor performance deterioration determination part 40 determines that the deterioration of performance of the compressor 12 has occurred when the discrepancy rate continues to be equal to or smaller than the first set value or equal to or larger than the second set value for one hour or more.

The reason for adopting this configuration is that the discrepancy rate between the amount of work (W) of the compressor and the amount of power consumption (kW) of the compressor may be temporarily equal to or smaller than the first set value or equal to or larger than the second set value depending on the cooling load of the vehicle interior or the travel condition of the vehicle.

Referring again to FIG. 1, the compressor performance deterioration determination part 40 outputs a compressor performance deterioration warning signal S1 when the deterioration of performance of the compressor 12 is determined according to the discrepancy rate between the amount of work (W) of the compressor and the amount of power consumption (kW) of the compressor. In particular, the compressor performance deterioration warning signal S1 is outputted to a compressor performance deterioration display part 50.

The compressor performance deterioration display part 50 is composed of a display part of a controller (not shown) for controlling the air conditioning system.

The compressor performance deterioration display part 50 may indicate the deterioration of performance of the compressor 12 with at least one of a symbol, a sign and a letter in response to the compressor performance deterioration warning signal S1 outputted from the compressor performance deterioration determination part 40.

Accordingly, the driver of the vehicle is notified that an abnormality has occurred in the compressor 12 of the air conditioning system. This informs the necessity of replacement of the compressor 12.

Next, an operation example of the vehicular air conditioning system having such a configuration will be described in detail with reference to FIGS. 1 and 2.

Referring first to FIG. 2, the air conditioning system is turned on (S101). In this state, data such as a rotation speed (rpm) of the compressor, a specific heat ratio (Cp/Cv) of the refrigerant, a low pressure/high pressure ratio in the air conditioning system, and the like are calculated to calculate an amount of work (W) of the compressor 12 in real time (S103).

When the calculation of the amount of work (W) of the compressor 12 is completed, the discrepancy rate between the amount of work (W) of the compressor and the amount of power consumption (kW) of the compressor is calculated in real time by the formula [1] described above (S105).

When the calculation of the discrepancy rate between the amount of work (W) of the compressor and the amount of power consumption (kW) of the compressor (hereinafter abbreviated as “discrepancy rate”) is completed, the compressor performance deterioration determination part 40 determines whether the calculated discrepancy rate falls within a range larger than a first set value (0.75) and smaller than a second set value (1.25) as represented by the formula [2] described above (S107).

As a result of the determination, if the discrepancy rate falls within a range larger than a first set value (0.75) and smaller than a second set value (1.25), the compressor performance deterioration determination part 40 determines that the performance of the compressor 12 is normal (S109).

On the other hand, if the discrepancy rate does not fall within a range larger than a first set value (0.75) and smaller than a second set value (1.25) (S107-1), the compressor performance deterioration determination part 40 determines whether the discrepancy rate is equal to or smaller than the first set value (0.75) or equal to or larger than the second set value (1.25) (S111).

As a result of the determination, if the discrepancy rate is equal to or smaller than the first set value (0.75) or equal to or larger than the second set value (1.25), the compressor performance deterioration determination part 40 determines that the performance of the compressor 12 has deteriorated (S113).

If it is determined that the performance of the compressor 12 has deteriorated, the compressor performance deterioration determination part 40 outputs a compressor performance deterioration warning signal S1 (S115).

When the compressor performance deterioration warning signal S1 is outputted, the compressor performance deterioration display part 50 indicates the deterioration of performance of the compressor 12 with at least one of a symbol, a sign and a letter (S117).

Then, the driver of the vehicle recognizes the deterioration of performance of the compressor 12 and recognizes the necessity of replacing the compressor 12.

According to the vehicular air conditioning system of the present invention having such a structure, it is possible to determine the performance deterioration of the compressor 12 based on the amount of work (W) of the compressor and the amount of power consumption (kW) of the compressor 12, and notify the user of the determination result.

In addition, since the performance deterioration of the compressor 12 is determined and notified to the user, it is possible for the user to take a prompt measure when the performance of the compressor 12 deteriorates. This makes it possible to prevent the deterioration in cooling performance of the vehicle interior and the excessive energy consumption due to the deterioration in performance of the compressor 12.

In addition, since the deterioration in cooling performance of the vehicle interior and the excessive energy consumption due to the deterioration in performance of the compressor can be prevented, it is possible to improve the comfort in the vehicle interior and the fuel efficiency of the vehicle.

While the preferred embodiments of the present invention have been described above, the present invention is not limited to the above-described embodiments. Various modifications and changes may be made without departing from the scope and spirit of the present invention defined in the claims.

1. A vehicular air conditioning system, comprising:
a compressor configured to compress a gaseous refrigerant to have a high temperature and a high pressure while an output rotation speed thereof is variably controlled according to a cooling load in a vehicle interior; and
a compressor performance deterioration determination part configured to determine whether or not the performance of the compressor has deteriorated according to the magnitude of a difference between an amount of work (W) of the compressor and an amount of power consumption (kW) of the compressor.

2. The system of claim 1, wherein the amount of work (W) of the compressor is determined by using a low pressure side refrigerant pressure value at an inlet of the compressor and a high pressure side refrigerant pressure value at an outlet of the compressor.

3. The system of claim 2, wherein the amount of work (W) of the compressor is determined according to a ratio of a high pressure side refrigerant pressure to a low pressure side refrigerant pressure.

4. The system of claim 1, wherein the amount of work (W) of the compressor is determined according to a rotation speed (rpm) of the compressor.

5. The system of claim 1, wherein the compressor performance deterioration determination part is configured to calculate a discrepancy rate between the amount of work (W) of the compressor and the amount of power consumption (kW) of the compressor in real time by the following formula [1]: discrepancy rate=amount of work (W) of compressor/amount of power consumption (kW) of compressor, and determine whether or not the performance of the compressor has deteriorated depending on whether or not the discrepancy rate between the amount of work (W) of the compressor and the amount of power consumption (kW) of the compressor falls within a range larger than a predetermined first set value and smaller than a predetermined second set value set to be larger than the first set value as represented by the following formula [2]: first set value<discrepancy rate<second set value.

6. The system of claim 5, wherein if the discrepancy rate between the amount of work (W) of the compressor and the amount of power consumption (kW) of the compressor falls within the range larger than the first set value and smaller than the second set value, the compressor performance deterioration determination part determines that the performance of the compressor is normal.

7. The system of claim 6, wherein if the discrepancy rate between the amount of work (W) of the compressor and the amount of power consumption (kW) of the compressor is equal to or smaller than the first set value or equal to or larger than the second set value, the compressor performance deterioration determination part determines that the performance of the compressor has deteriorated.

8. The system of claim 7, wherein the compressor performance deterioration determination part determines that the performance of the compressor has deteriorated, only when the discrepancy rate between the amount of work (W) of the compressor and the amount of power consumption (kW) of the compressor continues to be equal to or smaller than the first set value or equal to or larger than the second set value for a predetermined time or more.

9. The system of claim 8, further comprising:
a compressor performance deterioration display part configured to indicate the deterioration of performance of the compressor with at least one of a symbol, a sign and a letter and inform a user of the deterioration of performance of the compressor when the compressor performance deterioration determination part determines that the performance of the compressor has deteriorated.

10. The system of claim 9, wherein the compressor performance deterioration display part is a display part of a controller for controlling the vehicular air conditioning system.

11. The system of claim 8, wherein the first set value is 0.75, and the second set value is 1.25.
